(19) United States
(12) Patent Application Publication
(10) Pub. No.: US 2003/0179446 A1
(43) Pub. Date: Sep. 25, 2003

(54) Portable microscopic visualization tube for determining ovulation from saliva assay

(76) Inventor: Gary Yeh, Taipei (TW)

Correspondence Address: Gary YEH, PO Box 82-144, TAIPEI, TW

(21) Appl. No.: 10/102,716

(22) Filed: Mar. 22, 2002

(51) Int. Cl. G02B 21/00

(52) U.S. Cl. 359/368; 359/380

(57) ABSTRACT

A portable microscopic visualization tube for determining ovulation from saliva assay is disclosed. A portable microscopic visualization tube for determining ovulation period from saliva having a microscopic lens module, a beam tube, an electric powered LED mechanism, and a tube cap, and the LED mechanism includes a button battery seat, characterized in that the mounting position of the edge of the button seat and the inner wall of the beam tube is correspondingly formed into engageable recessing block or protruding block such that the entire LED mechanism can be withdrawn from the beam tube to replace the button battery within the button battery seat.

### BACKGROUND OF THE INVENTION

(a) Field of the Invention

The present invention relates to a microscopic visualization tube for determining ovulation period. The batteries disposed to the battery seat of the tube can be replaced.

(b) Description of the Prior Art

In view of contraception and enhancing fertility, the determination of ovulation period is important. In respect to enhancing fertility, generally, a woman who wishes to become pregnant has two main alternatives. She can either take ovulation-enhancing drugs; or she can predict the time of ovulation and intercourse at that time for the purpose of conception. One method of detecting and timing ovulation that is simple and well known is recording the basal body temperatures when a woman is waking at morning. The method is based on the fact that a rise in temperature indicates that ovulation has occurred.

Some researchers believe that the best fertile time of an ovum may not be more than 12 hours. However, spermatozoa are thought to be viable up to 72 hours in the female genital tract. For a woman desiring to become pregnant, it definitely would be advantageous to know when ovulation occurs.

On the other hand, contraception is needed for a woman who does not want to become pregnant. Various natural methods of contraception are referred to as the safe period, this method usually requires that couples abstain from intercourse for at least eight days approximately at midcycle between the menses. It is through that the ovum released from the ovary is susceptible to fertilization for only 12 hours; and that the spermatozoa deposited in the female reproductive tract are capable of fertilizing the ovum for only 72 hours. Thus, if intercourse did not occur just before and during this period, the spermatozoa could not fertilize the ovum and conception could not take place. This in theory is a safe and simple method of contraception.

However, in practice, the safe period method has some difficulties. If a woman has regular menstrual cycles, then this method is reliable, because she can readily know from the calendar the safe days after and before ovulation and restrict intercourse accordingly. But menstrual and/or ovulation cycles in many women are often irregular, in particular, as a result of work pressure, for example, the menstrual cycle may vary as long as 7 to 13 days for the peak reproductive years and by even greater margins for girls in their teens and women approaching menopause. It is not completely reliable to predict the ovulation time by simply estimating from the estimated next menstrual commence day.

Accordingly, a portable microscopic visualization tube has been designed to determine the ovulation timing by assaying saliva from a woman. This is a very convenient and reliable device when ovulation has taken place. Thus the device of the present invention is useful for contraception and/enhance fertility.

FIGS. 1A to 1C show a conventional microscopic visualization tube for determining ovulation period comprises a microscopic lens module 10, a beam tube 20, an electric-powered LED mechanism 30, and a tube cap 40. One end of the beam tube 20 is mounted with the microscopic lens module 10 and the other end is disposed with the electric-powered LED mechanism 30. The beam tube is installed at the external wall of the tube end of the LED mechanism 30 and is a protruded from the tube cap urging wall 21. The tube cap 40 is mounted from the beam tube 20 at one end of the microscopic lens module 10. The LED mechanism 30 includes a button battery seat 31, a LED body 32, and a press switch 33. The top face of the seat 31 is electrically connected to the LED body 32, and the other end of the LED body 32 connected to the button battery seat 31 is electrically connected to a press switch 33. The pressing end 33A is protruded above the seat 31. When the pressing end 33A is triggered, the LED body 32 is lighted to illuminate the interior of the beam tube 20 and all the lenses of the microscopic lens module 10. The microscopic lens module 10 includes an eyepiece 11 and an object lens 12. When using the device, the tube cap 40 is separated from the beam tube 20, and the microscopic lens module 10 is separated from the beam tube 20. All the lens surfaces are cleaned and saliva for diagnosis is placed on the surface of the object lens 12. After the saliva is dried (for about 8 to 10 minutes), the microscopic lens module 10 is inserted back to the beam tube 20.

The observer holds the beam table 20 and the eyepiece 11 is made close to one eye, the pressing end 33A is triggered to illuminate all the lenses of the microscopic lens module 10 so that the surface of the object lens 12 produces an image. If the image is a dispersed distribution, it is a non-ovulation period. If the image is a crystalline, leave veins distribution, it is an ovulation period. However, the drawbacks of such device are that

(1) the battery cannot be replaced unless the beam tube 20 is demolished.

(2) if the battery is exhausted after an extended period of time, it has to be discarded.

Accordingly, it is an object of the present invention to provide a portable microscopic visualization tube for determining ovulation from saliva assay which has a simple structure allowing the replacement of batteries and overcomes the above drawbacks.

### SUMMARY OF THE INVENTION

An object of the present invention is to provide a portable microscopic visualization tube for determining ovulation period from saliva having a microscopic lens module, a beam tube, an electric powered LED mechanism, and a tube cap, and the LED mechanism includes a button battery seat, characterized in that the mounting position of the edge of the button seat and the inner wall of the beam tube is correspondingly formed into engageable recessing block or protruding block such that the entire LED mechanism can be withdrawn from the beam tube to replace the button battery within the button battery seat.

Other objects, and advantages of the present invention will become more apparent from the following description taken in conjunction with the accompanying drawings.

### BRIEF DESCRIPTION OF THE DRAWINGS

FIG. 1A is a perspective view showing a conventional portable microscopic visualization tube for determining ovulation period by assaying saliva.

FIG. 1B is an exploded perspective view showing a conventional portable microscopic visualization tube for determining ovulation period by assaying saliva.

FIG. 1C is a sectional view showing a conventional portable microscopic visualization tube for determining ovulation period by assaying saliva.

FIG. 2 is a perspective view of a portable microscopic vision tube for determining ovulation period by assaying saliva in accordance with the present invention.

FIG. 3 is an exploded perspective view of the microscopic vision tube showing the tube cap of FIG. 2 being withdrawn in accordance with the present invention.

FIG. 4 is an exploded perspective view of FIG. 2 in accordance with the present invention.

FIG. 5 is a sectional view and exploded view of FIG. 2 in accordance with the present invention.

FIG. 6 is a sectional view of FIG. 2 in accordance with the present invention.

FIGS. 7A-7D shows the sequence of operation of a portable microscopic visualization tube for determining ovulation from saliva assay in accordance with the present invention.

FIG. 8A is an image showing non-ovulation period.

FIG. 8B is an image showing ovulation period.

### DETAILED DESCRIPTION OF THE PRESENT INVENTION

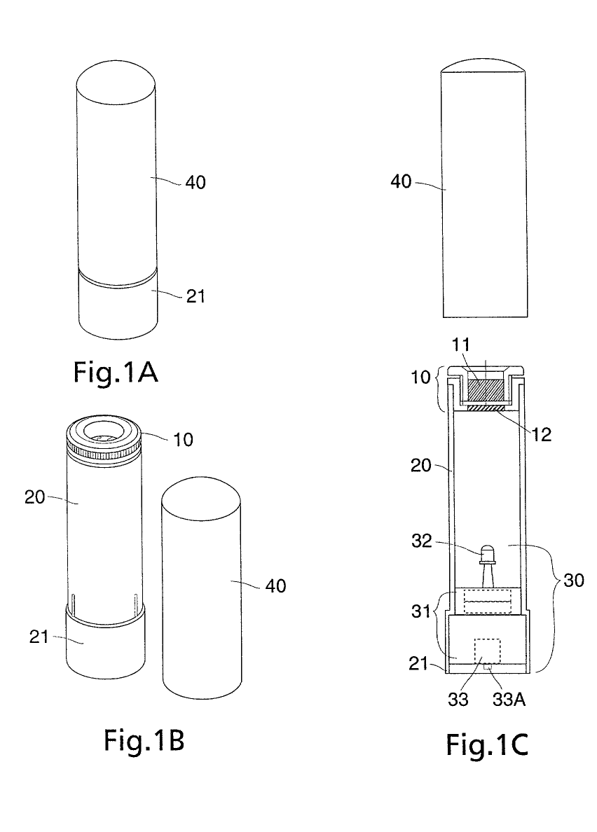

FIGS. 1A-1C show a conventional portable microscopic visualization tube for determining ovulation period from saliva.

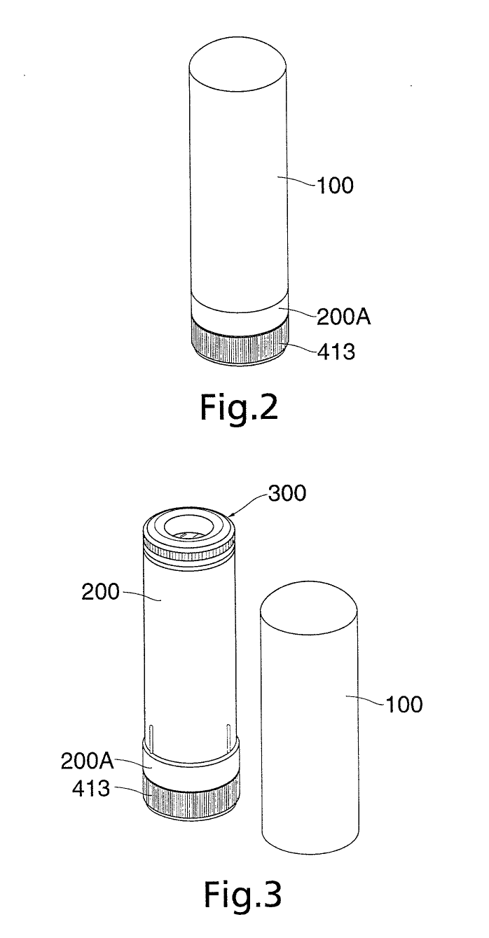

As shown in FIGS. 2 to 4, there is shown a portable microscopic visualization tube for diagnosing ovulation period from saliva in accordance with the present invention. As shown in FIG. 3, the microscopic visualization tube comprises a microscopic lens module 300, a beam tube 200, an electric-powered LED mechanism 400, and a tube cap 100. One end of the beam tube 200 is mounted to the microscopic lens module 300 and the other end of the beam tube 200 is mounted within the LED mechanism 400 such that the external wall of the tube end is protruded the urging wall 200A of the tube cap 100. The tube cap 100 mounts the beam tube 200 and the LED mechanism 400 includes a button battery seat 410, a LED 420 and a press switch 430. At the top face of the button battery seat 410, the LED 420 is electrically connected, and the button battery seat 410 connected the LED 420 at the other end is connected electrically the press switch 430, and the pressing end 431 protruded the button battery seat 410. The press end 431 is pressed the LED 420 is lighted to illuminate the interior of the beam tube 200 and the lens face of the microscopic lens module 300. After that, one leg of the LED 420 is connected to the resistor 400 and then is connected to the button 411 within the button seat 410. The button seat 410 is a seat frame having a filling hole 412 at the side of the seat, facilitating the loading of the button battery 411 through the filling hole 412. The bottom edge of the button seat 410 has a protruded rotating ring 413 which can stack at the bottom end of the tube cap urging wall 200A. This facilitates the holding of the rotating ring 413 and to unload the ring 13 from the button seat 410. The microscopic lens module 300 includes an external threaded tube 302 for connection with an eyepiece and the internally threaded tube plug 304 for connection with an object lens 303.

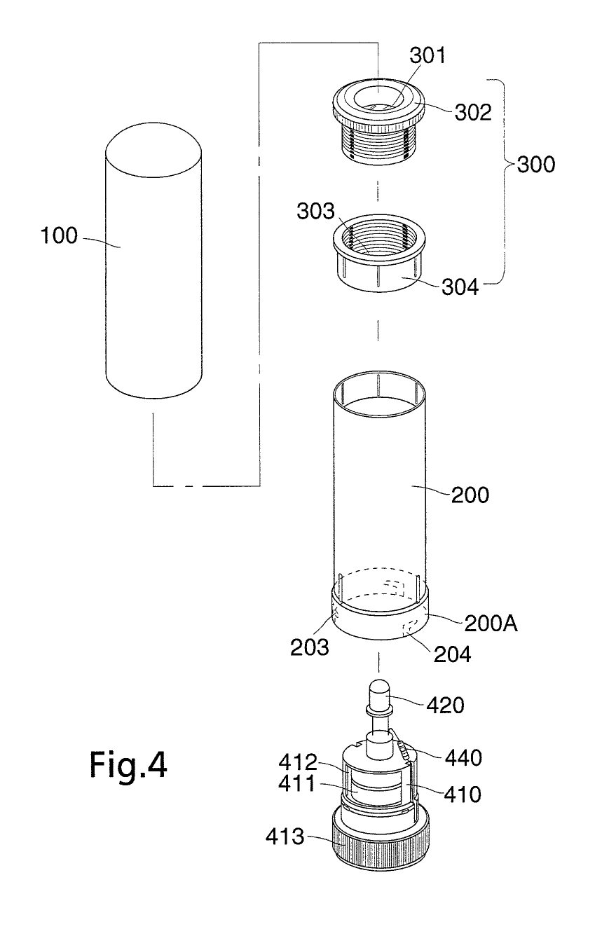

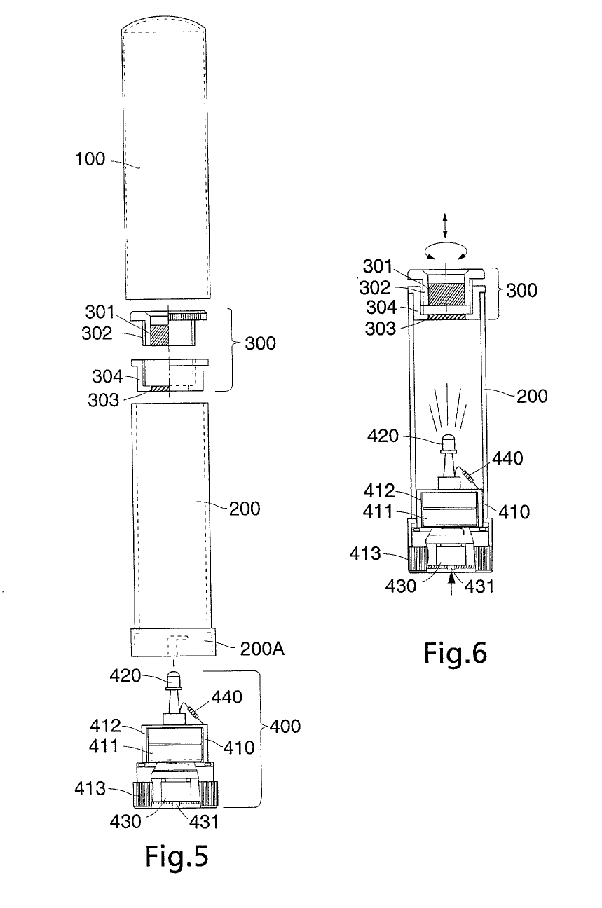

In accordance with the present invention, the mounting position of the circumferential edge of the button seat 410 and the inner wall of the beam tube 200, as shown in FIG. 4, is corresponding provided with a protruding blocks 201, 202 and recessing blocks 203, 204. The protruding blocks 201, 202 can be formed at the edge of the button seat 410, and the recessing blocks 203, 204 are recessing bodies located at the inner edge of the mouth of the beam tube 200 to correspondingly mount to the protruding blocks 201, 202 o the protruding blocks 201, 202 are provided at the inner edge wall of the beam tube 200, and the recessing blocks 203, 204 are provided at the edge wall of the button seat 410. In manufacturing, adhesive is used to adhere the button seat 410 and the beam tube 200. The button battery seat 410 is mounted directly to the beam tube 200, facilitating replacement if the batteries are exhausted. The button seat 410 is unscrewed from the beam tube 200 so as to replace the button battery 411 from the button seat 410. The seat 410 is then screwed back to the beam tube 200.

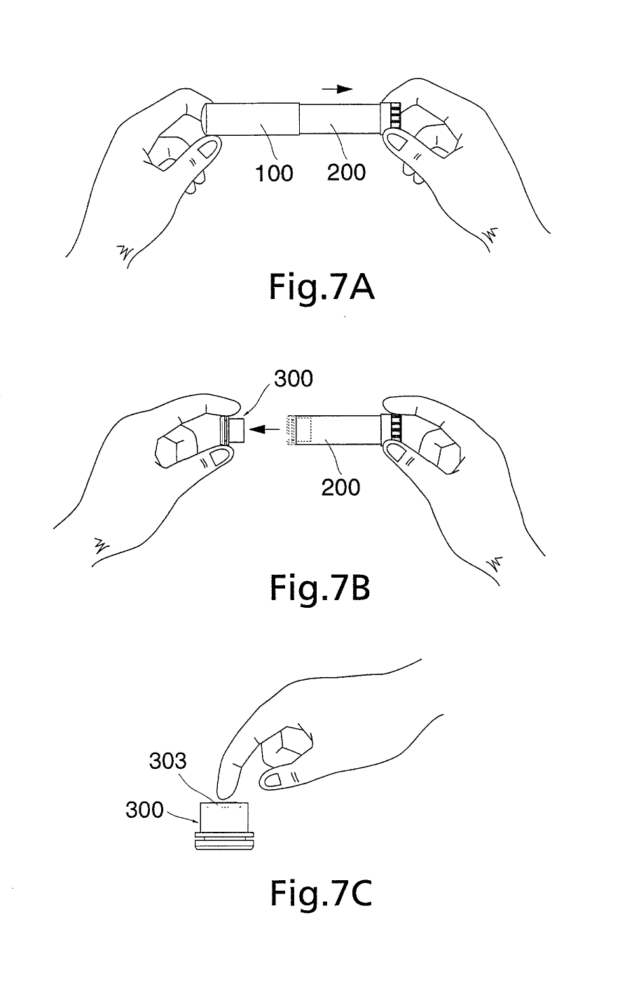

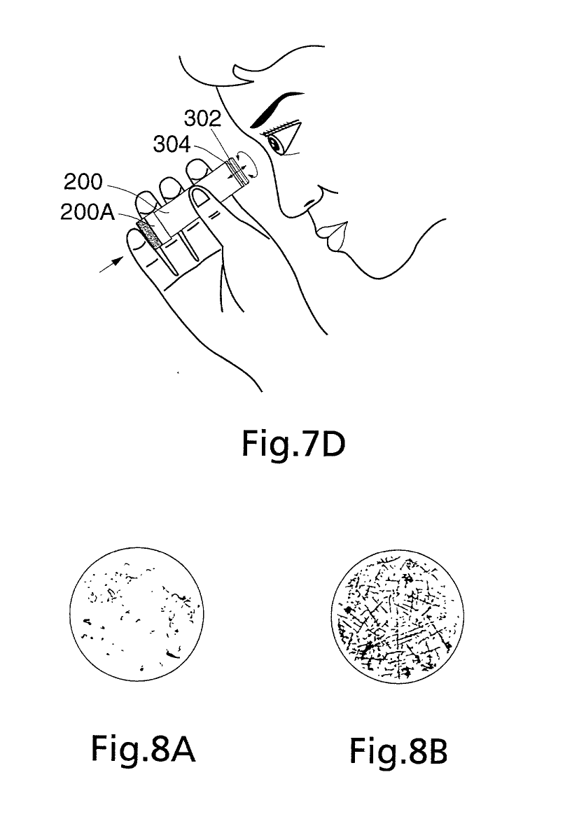

As shown in FIG. 6, after the tube cap 100 is unloaded from the tube cap 100, the pressing end 431 is triggered to illuminate the various lens of the microscopic lens module 300. The exterior of the externally threaded tube 302 is triggered, the distance between the object lens 303 and the eyepiece lens 301 is adjusted. In operation, the sequence is shown in FIGS. 7A-7D, the tube cap 100 is separated from the beam tube 200, and the microscopic lens module 300 is separated from the beam tube 200 clean the surfaces of all the lenses, a trace of saliva of the tester is placed on the surface of the object lens 303. After the saliva is dried (about 10 minutes), the microscopic lens module 300 is plugged into the beam tube 200. At this instance, the observer holds the beam tube 200. One eye gets close to the eyepiece 301 and a finger triggers the pressing end 431 to illuminate various lenses of the microscopic module 300. The exterior of the external threaded tube 302 is triggered, and the focal distance of the object lens 303 and the eyepiece 301 is adjusted such that the correct image of the dried saliva on the object lens 12 is produced.

As shown in FIG. 8A, if the image of the saliva is a dispersed distribution, it indicates that it is a non-ovulation period. As shown in FIG. 8B, if the image of the saliva is a crystalline, leave veins distribution, it indicates that, that particular day is an ovulation period. A new button battery 411 can be replaced the exhausted one.

While the invention has been described with respect to preferred embodiments, it will be clear to those skilled in the art that modifications and improvements may be made to the invention without departing from the spirit and scope of the invention. Therefore, the invention is not to be limited by the specific illustrative embodiment, but only by the scope of the appended claims.

1. A portable microscopic visualization tube for determining ovulation period from saliva having a microscopic lens module, a beam tube, an electric powered LED mechanism, and a tube cap, and the LED mechanism includes a button battery seat, characterized in that the mounting position of the edge of the button seat and the inner wall of the beam tube is correspondingly formed into engageable recessing block or protruding block such that the entire LED mechanism can be withdrawn from the beam tube to replace the button battery within the button battery seat.

2. The portable microscopic visualization tube for determining ovulation period from saliva of claim 1, wherein the button battery seat is a seat frame having at least one filling hole at the side of the seat, and the button battery is unloaded from the filling hole.

3. The portable microscopic visualization tube for determining ovulation period from saliva of claim 1, wherein the protruding block is located at the edge of the button seat, and the recessing block is a rotatable recess at the inner edge of the beam tube engageable with the protruding block.

4. The portable microscopic visualization tube for determining ovulation period from saliva of claim 1, wherein the protruding block is located at the inner edge wall of the beam tube and the recessing block is located at the edge wall of the button battery seat.

5. The portable microscopic visualization tube for determining ovulation period from saliva of claim 1, wherein the electric--powered LED mechanism includes a resistor connected to the leg of a LED to the button battery within the button seat.

6. The portable microscopic visualization tube for determining ovulation period from saliva of claim 1, wherein the bottom edge of the button battery seat is provided with a rotating ring facilitating the turning of the button seat and the rotating ring urges the wall of the bottom end of the tube cap.
